(19) United States
(12) Patent Application Publication
(10) Pub. No.: US 2008/0248182 A1
(43) Pub. Date: Oct. 9, 2008

(54) Device with a Membrane on a Carrier, as Well as a Method for Manufacturing Such a Membrane

(76) Inventors: Tjeerd Jongsma, Bennekom (NL); Roelof Bos, Zwoile (NL); Wietze Nijdam, Zutphen (NL); Cornelis Johanness Maria Van Rijn, Hengelo(gld) (NL)

Correspondence Address: YOUNG & THOMPSON, 209 Madison Street, Suite 500, ALEXANDRIA, VA, 22314, US

(21) Appl. No.: 11/579,396

(22) PCT Filed: Apr. 29, 2005
(86) PCT No.: PCT/NL2005/00331

§ 371 Date: Jan. 3, 2007

(30) Foreign Application Priority Data
May 3, 2004 (NL) NL 1026097
Jun. 30, 2004 (NL) NL 1026530

(51) Int. Cl. B01D 71/02; B01D 69/10; A01J 11/06; C23F 1/02; G01N 27/20

(52) U.S. Cl. 426/580; 428/316.6; 428/120; 428/34.1; 428/158; 428/310.5; 428/312.6; 428/212; 428/305.5; 428/110; 427/79; 210/650; 210/489; 216/41; 324/693

(57) ABSTRACT

A membrane on a carrier for filtration of liquids includes a carrier and a membrane. Also described is a method for manufacturing a membrane on a carrier as disclosed. Additionally described is the application of a membrane on a carrier as well as to a module including such a membrane. Also described is a method for determining fracture in such a membrane on a carrier.

The invention relates to a device, in particular for filtration of liquids, comprising a membrane on a carrier. The invention also relates to a method for manufacturing a device with a membrane on a carrier. The invention further relates to application of a device with a membrane on a carrier according to the invention as well as to a module comprising such a membrane on a carrier. The invention also relates to a method for determining fracture in such a membrane on a carrier.

A filtration membrane is known from American patent U.S. Pat. No. 5,753,014. This filtration membrane comprises a membrane with membrane openings. These membrane openings have a pore size of 5 nm (nanometres) to 50 micrometres. The membrane can be formed by deposition of a thin layer on a carrier by means of for instance a suitable vapour deposition or spin coating. Perforations are then made in the thus formed membrane, for instance by means of etching after a lithography step. It is further stated that such a membrane can serve as a carrier for the deposition of a separating layer, for instance for ultrafiltration, gas separation or catalysis.

If a carrier is present, this carrier can be etched away completely or be provided with carrier openings having a diameter greater than that of the membrane openings in the membrane. In the first case only the membrane remains, in the second case the membrane is supported by the carrier.

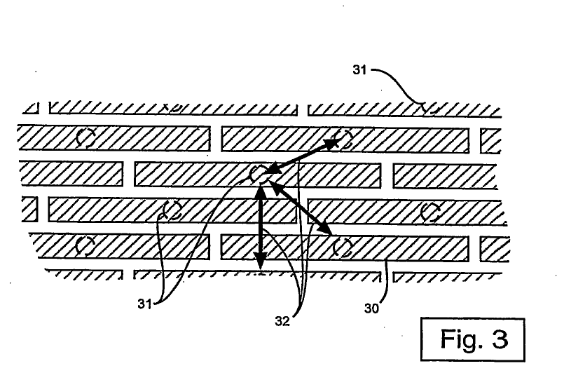

A drawback of such membrane filters according to this American patent is however that they are mechanically weak. The walls of the carrier openings of the thus formed membrane carriers consist substantially of crystal surfaces if crystalline starting material is used, for instance the <111> orientation in the case of [100] or [110] silicon. This mechanism is inherent to the method applied in this American patent. This means that in the case of mechanical load possibly present fracture lines can easily lead to fracture of the carrier, and thus of the filtration membrane. Although it is further possible with the techniques known at the time of this American patent to etch a pattern in the outer part of a carrier or in a layer applied thereto, etching of this pattern through the carrier entails significant drawbacks. With these techniques it is for instance not possible, or hardly so, to prevent underetching (see FIG. 2). In this respect underetching is understood to mean the phenomenon known to the skilled person wherein etching takes place under a protective layer such as a lacquer coat. The underlying structure is hereby unintentionally affected adversely.

Furthermore, in the case a silicon [100] or [110] wafer is used and an anisotropic etching technique is used, round or almost round carrier openings are not obtained. The <111> directions after all determine the preferred etching directions in this case, whereby diamond-shaped carrier openings are formed, which are also tapering. Each carrier opening which does not run substantially straight further has the further drawback that the flow through such a carrier opening is further obstructed. Nor is it possible with the filtration membranes formed in this U.S. Pat. No. 5,753,014 patent to monitor the integrity of the membrane and/or carrier without interrupting the production in a device. This is disadvantageous for the degree of capacity utilization of such a device.

With such a membrane according to the U.S. Pat. No. 5,753,014 patent it is further not possible to monitor the action in respect of for instance filtration efficiency and microscopic fractures.

An object of the present invention it to provide a strengthened membrane on a carrier.

In order to achieve the intended object, a membrane on a carrier of the type stated in the preamble has the feature according to the invention that the carrier opening has a rounded cross-section.

Surprisingly, it has been found that if the carrier openings have a rounded cross-section an improved mechanical strength is obtained. If the rounding has a radius of curvature greater than 3 micrometres and preferably greater than 5 micrometres, the mechanical strength of the membrane can then increase by more than 50% compared to carrier openings in which there are local imperfections or edges with a smaller radius of curvature. This strength can surprisingly be increased further by embodying the carrier openings with a very low surface roughness of smaller than 3 micrometres, and in particular smaller than 0.3 micrometres, whereby crack initiation is in large measure prevented.

If the surface roughness is smaller than 3 micrometres, the mechanical strength is then improved by a minimum of about 30%. At a surface roughness lower than 0.3 micrometres, it is improved by a minimum of 80%. The mechanical strength is determined by clamping and then loading the membrane with carrier relatively uniformly and herein determining the failure pressure.

For filtration applications the membranes with carrier are usually clamped and supported in a membrane holder which is provided with a number of parallel support bars. The distribution and the size of the carrier openings in the carrier of the membrane relative to said support bar can, if desired, be optimized so that the stress distribution of the carrier is distributed as optimally as possible.

A particular embodiment with a high mechanical load-bearing capacity has the feature that a pattern of carrier openings is arranged in the carrier such that a first part-pattern has a high density of carrier openings, a second part-pattern adjacent to the first part-pattern has a less high density of carrier openings, and a third part-pattern adjacent to the second part-pattern has a very low or no density of carrier openings in order to clamp the membrane with carrier in a membrane holder without damage, and wherein mechanical stress build-up in the carrier is also reduced. Density is here understood to mean a measure for the open surface area of openings in relation to a given total surface area. The density in the second part-pattern is preferably less than half the density in the first part-pattern. The mechanical strength can thus be improved by a minimum of 30%. In another embodiment the density of carrier openings is not modified in stepwise manner per part-area but this density varies smoothly in order to distribute the mechanical stress build-up as well as possible, the mechanical strength hereby being improved by a minimum of 50%.

It has been found surprisingly that a significantly greater mechanical strength (>20%) is already obtained by providing the carrier with continuous elongate sieve tracks. A further embodiment of a device of the type stated in the preamble therefore has the feature according to the present invention that the carrier is provided with continuous sieve tracks. Continuous is here understood to mean that the sieve tracks are not interrupted by for instance strips placed perpendicularly thereof in which no carrier openings are present. Extra strength for the membrane on the carrier is obtained by providing the carrier with such sieve patterns, without too much surface area remaining unused for the actual filtering application.

A subsequent object of the present invention is to provide a membrane on a carrier which is provided with means enabling monitoring of the integrity of the membrane on a carrier.

Surprisingly, it has now been found that such a membrane on a carrier can be obtained by providing it with at least an electrical conductor. It is hereby even possible to monitor the integrity of the membrane on a carrier in the production process itself.

The present invention therefore relates to a membrane on a carrier which is provided with at least one electrical conductor, with which the integrity of the membrane as well as the action of the membrane can be monitored without disrupting a production process.

A better degree of capacity utilization of production equipment and a better controlled action of the membrane are for instance hereby obtained.

A subsequent object of the present invention is to provide a method for manufacturing a strengthened membrane on a carrier.

It has now been found, surprisingly, that by first etching a pattern in a second side of a carrier or in the layer applied thereto, and etching this through in a subsequent step, carrier openings are obtained which have a desired size, depth and tapering without the above mentioned drawbacks. The present invention therefore relates to a method for manufacturing such a membrane on a carrier.

A membrane on a carrier according to the invention is particularly suitable for the filtration of a fluid, in particular of liquids, since it has on the one hand an excellent and selectively separating capacity for particles of different sizes and can on the other hand be applied easily. A membrane on a carrier according to the invention is otherwise also particularly suitable for the separation of particles with different sizes in a gas. This separation can even be improved further using two membranes in series. Particles with a specific size range can also be separated with two membranes in series by means of fractionation.

A membrane on a carrier according to the invention is moreover much better able to withstand the occurrence of fractures. This is a significant advantage because for instance the membrane on a carrier hereby needs much less frequent replacement. This improves the degree of capacity utilization of a process device. A significant advantage of fewer fractures is moreover that a separation continues to proceed much more homogeneously. In addition, much less fouling occurs compared to usual filters. The inventors believe this is caused by the thin and smooth surface of the membrane. Owing to a particular design of inter alia the membrane openings in the membrane on a carrier, the membrane on a carrier according to the invention can also be back-flushed and/or back-pulsed more easily compared to other filters, whereby cleaning is simplified and improved. This back-flushing and/or back-pulsing further enhances general filtration because the filtration proceeds better after flushing and back-flushing and/or back-pulsing are necessary less often or for less time, so that for instance less process time is lost.

The membrane on a carrier according to the invention is furthermore much stronger than heretofore usual and comparable membranes, in the sense that it is possible to withstand much greater pressures.

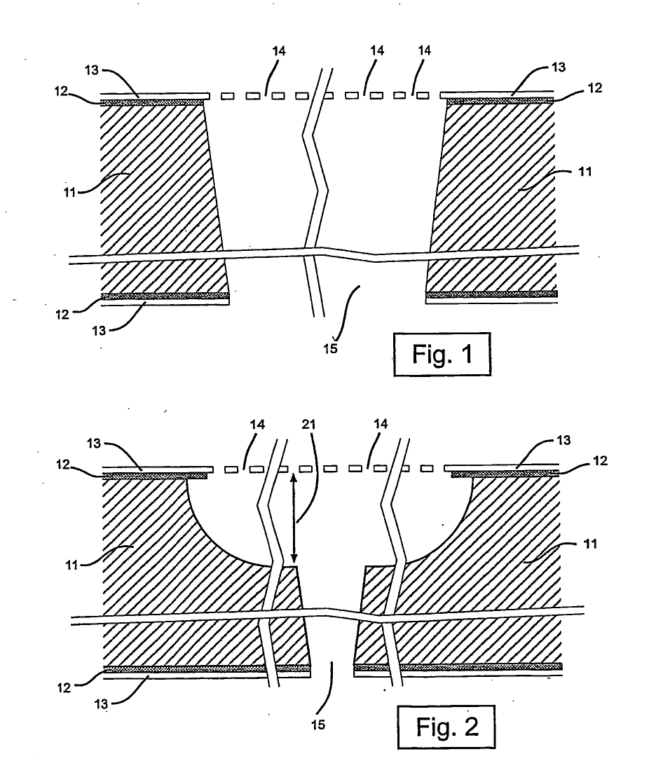

FIG. 1 shows a schematic cross-section of an example of a membrane on a carrier. FIG. 1 describes a membrane 13 provided with membrane openings 14 and a carrier 11 which is covered on two sides with an extra layer 12, wherein layer 13 can be an optionally protective layer. Layer 13 is for instance a layer of Si₃N₄, layer 12 is for instance a layer of SiO₂, layer 11 is in that case crystalline Si, and 15 is a carrier opening in the carrier. Layer 12 is otherwise not strictly necessary and can be omitted in appropriate cases.

FIG. 2 shows a schematic cross-section of a comparable membrane on a carrier. The carrier is now provided with an additional “cup” 21. This cup is obtained by two etching steps instead of one. The underside is etched with an etching technique (DRIE) other than the upper side (isotropic wet chemical through the membrane) (see below for detail). An advantage is that a relatively large amount of Si-carrier material remains, which results in a stronger wafer, while as much effective filtration surface area as possible is realized. Cup 21 has a cross-section which can be about one to fifty times the cross-section of carrier opening 15, and preferably two to ten times. The diameter of carrier opening 15 can also be chosen so small that it can strongly limit the liquid flow in the case the membrane has defects, wherein non-filtered liquid can come into direct contact with the filtered liquid. The flow resistance of carrier opening 15 is preferably ten to fifty times lower than the flow resistance of membrane field 14.

FIG. 3 shows a schematic top view of an example of a membrane on a carrier, such as that of FIG. 2. The carrier is provided with carrier openings 31. The rectangular membrane fields 30 are arranged mutually offset and have a dimension of for instance 250 by 2500 micrometres. The round openings 31 in the carrier have a diameter of 200 micrometre, while the mutual distance 32 between openings 31 is a minimum of 800 micrometres, which greatly enhances the mechanical strength of the carrier while a large effective filtration surface area is obtained. The surface area of the membrane field is preferably two to twenty times greater than the cross-sectional area of the opening in the carrier.

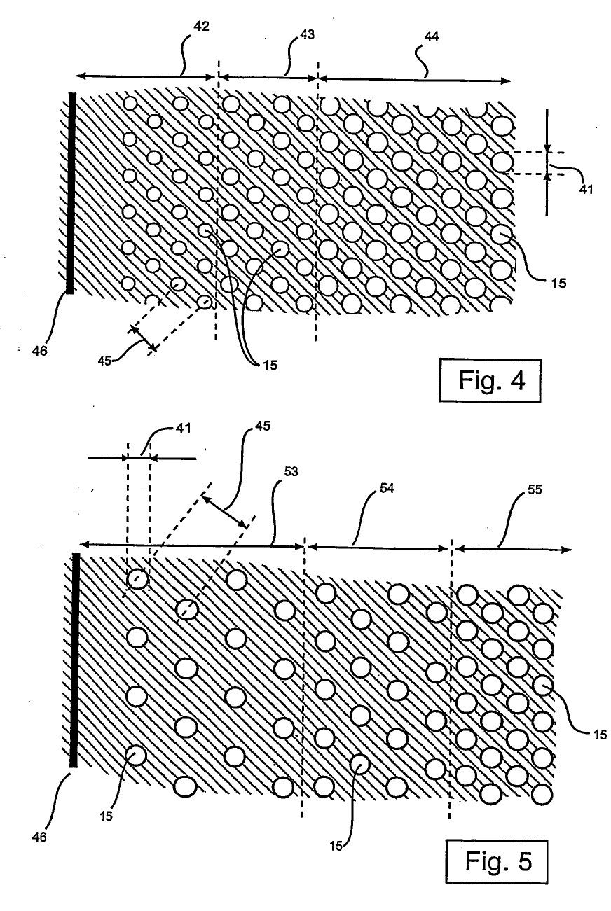

FIG. 4 shows a schematic bottom view of an example of a membrane on a carrier, such as that of FIG. 1. The carrier is provided with carrier openings 15. For a high mechanical load-bearing capacity the density of carrier openings is varied by selecting different sizes 41 for carrier openings 15 per part-pattern 42, 43, 44, while the centre-to-centre distance 45 of the carrier openings does not change, or hardly so. The stress distribution of the carrier can hereby be optimized. Close to support bar 46 the density of the carrier openings is low, while towards the centre, between two support bars, the density of the carrier openings becomes higher.

A particular embodiment of a membrane on a carrier with a high mechanical load-bearing capacity has the feature that a pattern of carrier openings is arranged in the carrier such that a first part-pattern 42 has a high density of carrier openings, a second part-pattern 43 adjacent to the first part-pattern has a less high density of carrier openings, and a third part-pattern 44 adjacent to the second part-pattern has a very low or no density of carrier openings, in order to clamp the membrane with carrier in a membrane holder without damage and wherein mechanical stress build-up in the carrier is also reduced.

FIG. 5 shows a variant of the example sketched in FIG. 4. In order to optimize the stress distribution in the carrier, in this figure it is not the size 41 of the carrier openings which is varied, but the centre-to-centre distance 45 between the carrier openings. This has the advantage that the etching process used, which is optimized for the diameter (a larger hole etches more rapidly), proceeds uniformly over the carrier.

In a first embodiment the invention relates to a membrane on a carrier wherein the carrier is provided with continuous sieve patterns.

The term “membrane” is understood to mean a layer which is provided with membrane openings. These membrane openings are highly uniform in respect of size, depth and shape. A membrane can consist of a material optionally deposited on a carrier. Suitable materials for the membrane are for instance inorganic or ceramic components such as silicon, carbon, silicon oxide, silicon nitride, silicon oxynitride, silicides, alumina, zirconium oxide, magnesium oxide, chromium oxide, titanium oxide, titanium oxynitride, titanium nitride and yttrium-barium-copper oxides. A metal or an alloy with palladium, lead, gold, silver, chromium, nickel, steel, a ferro-alloy, tantalum, aluminium and titanium can also be used as membrane material. The membrane can preferably be of silicon carbide or a diamond-like carbon (DLC or SP₃) layer, whereby higher mechanical loads are possible than for instance a membrane layer of silicon nitride is applied.

Another embodiment has the feature that the membrane is provided with a chemically inert, preferably hydrophilic coating layer, for instance a hydrophilic plastic layer, or an inorganic layer such as titanium oxide, carbide or silicon carbide. The membrane and/or a coating layer is further preferably electrically conductive, whereby it is possible during filtration and/or the cleaning to prevent fouling respectively to remove fouling. The thickness of this layer is preferably between 1 and 350 nanometres, sufficient for prolonged chemical load and not unnecessarily thick, whereby the membrane openings become too small.

The carrier and the membrane can be composed of different materials and can, if desired, also be provided with an intermediate layer such as for instance silicon oxide to improve the mechanical properties of the membrane layer, or to protect the membrane layer from for instance a reactive ion plasma during etching of the carrier openings in the carrier. Instead of silicon oxide a very thin titanium oxide or chromium oxide or other suitable oxide or nitride layer can for instance also be applied as etch stop layer.

There are in fact not many limitations to the choice of a material of a membrane. The most important limitations are that a membrane must be compatible with a carrier. This means that a membrane and a carrier must be sufficiently connected to each other by chemical or physical bonding. This can optionally be achieved by means of an intermediate layer. A membrane must further be suitable for a chosen application, it must for instance be non-toxic and chemically inert A preferred material for a membrane is however silicon nitride because of a relatively simple manner of depositing and chemical inertness.

The term “carrier” designates a structure which is intended to support a membrane. Particularly the mechanical properties of a membrane are hereby improved, without other properties being too adversely affected.

The carrier is normally connected to the membrane, for instance by depositing the membrane on the carrier. Suitable materials for the carrier of the membrane on a carrier according to the invention are preferably composed of inorganic or ceramic components. Examples hereof are silicon, carbon, silicon oxide, silicon nitride, silicon oxynitride, silicon carbide, silicides, alumina, zirconium oxide, magnesium oxide, chromium oxide, titanium oxide, titanium oxynitride and titanium nitride and yttrium-barium-copper oxides. A metal or an alloy with palladium, tungsten, gold, silver, chromium, nickel, steel, a ferro-alloy, tantalum, aluminium and titanium can also be applied as a carrier material. A polymer material can optionally be applied for the carrier, such as polyurethane, polytetrafluoroethylene (TEFLON), polyamide, polyimide, polyvinyl, polymethyl methacrylate, polypropylene, polyolefin, polycarbonate, polyester, cellulose, polyformaldehyde and polysulphone

For biomedical applications the carrier can be composed of a biocompatible material such as silicon nitride, silicon carbide, silicon oxynitride, titanium, titanium oxide, titanium oxynitride, titanium nitride, polyamide and polytetrafluoroethylene TEFLON). The carrier can also be provided with a biocompatible covering of these materials, or be provided with another biocompatible covering, for instance a heparin covering.

The carrier can consist of a macroporous material such as a tortuous pore structure, a sintered ceramic material, a sintered metal powder or a tortuous polymer membrane, as well as of an initially closed material in which carrier openings are made at a later stage, for instance a semiconductor wafer, a metal carrier or an inorganic disc. It is further even possible to work with polycrystalline silicon, as is usual in the solar cell industry, which is economically advantageous, while no preferred crystal orientations are present so that a membrane on a carrier can be realized which can be loaded a minimum of 20% more.

The mask on a membrane side preferably comprises a pattern with rectangular slots having a dimension of 0.1×0.1 micrometres to 5.0×5.0 micrometres. The advantage of such slots is that they can be readily transferred with existing lithographic techniques and have a good action. These slots are sufficiently selective, among other reasons because they can be formed sufficiently homogeneously.

The precise dimensions of the slots are determined by the application. Examples hereof are the filtering of micro-organisms from milk: 0.6-0.9 by 2.04.0 micrometres, filtering of fat 0.5−3.0×1.0−10 micrometres, filtering of proteins 0.05−0.1×0.1−0.5 micrometres.

The term “slot” is understood to mean a rectangular membrane opening. On the carrier side the mask preferably further comprises a pattern with substantially round membrane openings with a diameter of 100 micrometres to 1000 micrometres, more preferably with a diameter of 200 micrometres to 500 micrometres, most preferably with a diameter of 200 micrometres to 300 micrometres, wherein the sieve pattern of carrier openings lies in tracks 3-15 mm wide, with an unexposed space between the tracks of 1-8 mm. In a preferred embodiment these are tracks of about 8 mm wide and an intermediate space of about 3 mm. The thickness of the membrane is preferably 50 nm to 2 micrometres, very preferably 300 nm to 1.5 micrometre, most preferably about 1 micrometre. The choice of the thickness of the membrane depends among other factors on the choice of the size of the carrier openings in the carrier. For instance, if a thin membrane is chosen, the reduced strength hereof can be compensated by arranging smaller carrier openings in the carrier. It will be apparent to the skilled person that, in combination with other features of the membrane on a carrier, such parameters can be easily modified to obtain the desired properties such as selectivity, strength. If the layer becomes too thick, the deposition moreover takes proportionately longer, which is economically unattractive. If the layer is too thin, the layer provides insufficient action, for instance because it then has an insufficiently homogeneous thickness over the relevant distance range, and the layer is then not strong enough. The membrane can be of the above mentioned materials and is preferably of Si₃N₄.

Such a membrane on a carrier generally has sufficient strength to be able to withstand a pressure of about 7 bar, while membranes of similar type known heretofore can withstand only a pressure of a maximum of about 2 bar.

In a second embodiment, the invention relates to a membrane on a carrier wherein the carrier comprises carrier openings having walls with directions substantially differing from the preferred crystal orientation.

The term “crystal orientation” is here understood to mean a designation usual in crystallography for a vector related to the crystal lattice.

The term “preferred crystal orientation” refers to that orientation or those orientations occurring when a material such as a carrier is etched, particularly if the material is etched wet. In the case of Si for instance the <111> is the intended preferred crystal orientation in the case of a [100] surface. It is assumed that a drawback of such a preferred orientation is that the angles will be centres for stress during load and will act as points for the initiation of fracture of the carrier, and therefore also of the membrane.

If the formed carrier openings in the carrier also lie in a disadvantageous pattern (for instance all square sides of a carrier opening lie at a <100> orientation), a fracture then occurs relatively quickly. A mechanism is hereby inherently present which increases the chance of fracture along these dislocations, in particular in the case of mechanical load, which is disadvantageous for the lifespan of the membrane on a carrier.

In a typical example the carrier openings of the carrier will have a substantially round or oval cross-section, which to great extent prevents fracture formation.

In a third embodiment, the invention relates to a membrane on a carrier, wherein the walls of the carrier openings of the carrier are substantially perpendicular to the surface of the carrier, or have a positive tapering or a negative tapering, or have a combination hereof.

An example of such a membrane on a carrier is a carrier which is at least partly provided with carrier openings with a positively tapered profile. The angle of the profile relative to the normal of the carrier is in this case 1 to 25 degrees, in particular 5 to 15 degrees, as shown schematically in FIG. 1. If the angle becomes too great, the flow through the membrane on a carrier will become too limited. On the other hand, more carrier material is present in the case of a greater angle, which enhances the strength.

By the term “tapering” is understood the angle between the normal perpendicular to the surface and a vector along a wall of the etched carrier opening in the carrier. The carrier opening has the form of a conical structure which can be practically circular or more or less elliptical.

The term “positively tapered” is understood to mean a tapering wherein the carrier opening decreases in size from the outer surface of the carrier as seen in the direction of the membrane.

The term “negative tapering” designates a tapering wherein the carrier opening increases in size from the outer surface of the carrier as seen in the direction of the membrane.

In a subsequent embodiment, the invention relates to a membrane on a carrier, wherein the membrane and the carrier are each provided with a chemically inert protective layer. This layer is preferably a hydrophilic protective layer, for instance a hydrophilic plastic layer, or an inorganic layer such as titanium oxide or silicon carbide.

Both the membrane and the carrier are preferably provided with a protective layer. This protective layer serves to protect the membrane on a carrier from environmental influences and thus realize a longer lifespan of the membrane on a carrier.

This layer is further preferably hydrophilic, since the adhesion of particles to this layer is hereby reduced in the filtration of liquid. As the skilled person will appreciate, the choice of a hydrophilic layer will be related to a liquid for filtering and the effect to be achieved. A hydrophilic layer will generally be chosen in the case of an aqueous liquid. This choice is advantageous for the action of the membrane on a carrier.

The thickness of the protective layer is preferably 30 nm to 1 micrometre, more preferably 40 nm to 200 nm and most preferably about 50 nm. Too thin a layer provides insufficient protection, while forming of a thick layer takes too much time. The protective layer can be of the above stated materials and is preferably Si₃N₄. Not only is Si₃N₄ almost chemically inert for a great variation of applications, but it is moreover also a strong material. Although Si₃N₄ is not a hydrophilic material, it is otherwise sufficiently suitable.

The term “chemically inert” is understood to mean a property which ensures that, in the conditions in which the membrane on a carrier will be applied, it will be practically unaffected chemically during the lifespan of the membrane and carrier. The term “hydrophilic protective layer” designates a layer which is hydrophilic and protects the underlying layer against ambient influences such as for instance temperature, moisture, the applied liquid or gas, light etc.

In a subsequent embodiment, the invention relates to a membrane on a carrier provided with at least one electrical conductor enclosed by a dielectric. The term “electrical conductor” is understood to mean a material which conducts electrons to a sufficient degree. The electrical conductor consists of a structure which is significantly greater in one dimension (length) than in the two other dimensions (width and thickness). The electrical conductor can be seen as a wire running over the membrane and/or carrier.

Examples of materials which can be arranged as electrical conductor by accepted methods are tungsten, aluminum and silicon, which can optionally be doped to increase the conduction.

The purpose of such a conductor is to enable the integrity of the membrane and/or carrier to be determined more easily. This determination preferably takes place during use of the membrane on a carrier, for instance during the production or during breaks in production. The integrity of the membrane on a carrier can in this way be guaranteed more or less continuously or as often as necessary. If the membrane on a carrier no longer suffices, because integrity has been wholly or partly lost, it can be decided to replace the membrane on a carrier. This considerably increases the degree of capacity utilization of a used filtration device and improves the action of the membrane on a carrier.

The term “dielectric” designates a material which is not electrically conductive, or hardly so. Examples of such a material are Si₃N₄ and SiO₂. The dielectric insulates the electrical conductor from its surroundings, in any case in respect of the electrical conductivity.

In general the electrical conductor is wholly enclosed by a dielectric, with the exception of the contact points. The dielectric preferably consists of two layers which are deposited before and after the electrical conductor. The first layer insulates the electrical conductor from the substrate, the second insulates the conductor from the rest of the environment and/or subsequent layer. The dielectric can however also consist of a non-conductive or poorly conducting substrate and a layer which is deposited on the electrical conductor. It will be apparent to the skilled person that for the purpose of insulating the electrical conductor any usual technique or combination of techniques is suitable. In a subsequent embodiment, the invention relates to a membrane on a carrier provided with at least one electrical conductor in a first direction and at least one electrical conductor in a second direction, which second direction does not run parallel to the first direction. In a preferred embodiment according to the invention, at least one electrical conductor runs in the first direction and at least one electrical conductor runs in the second direction over each intersection of the membrane.

The term “intersection” designates the area between a number of adjacent membrane openings in the membrane, for instance four in the case of a rectangular grid. In this case the four said membrane openings lie pairwise one below the other or likewise adjacently of each other. They can for instance be ordered in a rectangle such as a square. By providing a membrane on a carrier with electrical conductors in such a manner, it is essentially possible to determine the integrity of each membrane opening separately. A local fracture will after all result in a changed, usually increased or very high resistance of the (in this example) two electrical conductors which cross an intersection at the position of the fracture. The location of a possible fracture can be determined by combining the information about the individual conductivities. This offers considerable advantages.

To begin with, the integrity of the membrane on a carrier can be monitored as a whole, wherein a continuous or semi-continuous measuring of the resistance of the present electrical conductor(s) can result directly in the replacement of the in that case defective membrane and carrier.

It is further possible to monitor the action of the membrane in time. More and more microscopic fractures will after all gradually be formed. This means that membrane openings of a greater size than the original membrane openings are in fact then formed. It hereby becomes gradually possible and increasingly easier for larger particles to pass through the membrane, and the separating efficiency thus decreases.

By monitoring the increase in the number of small fractures it can moreover be decided to replace or repair the whole membrane prematurely in order to thus prevent an anticipated fracture. This has the important advantage that unpurified material can be prevented from appearing further on in a process after the occurrence of a fracture.

In a subsequent embodiment, the invention relates to a method for manufacturing a membrane on a carrier, comprising the steps of

a. providing a membrane on a first side of the carrier, which carrier is provided on a second side with a layer for etching;

b. etching a pattern in the layer for etching on the second side of the carrier, and

c. etching the pattern obtained in step b) through the core of the carrier up to the membrane.

The term “etching” is understood to mean a chemical process with which a layer or a part of a layer is removed. The etching can be a wet etching step or a dry etching step. In step b) a pattern is firstly etched in the first layer on the second side of the membrane. After this pattern has been etched into this relatively thin layer, the etching is stopped. The etching of this pattern is preferably carried out with RIE. The carrier itself is then not etched, or hardly so. In step c) the same pattern is then etched through the carrier with a different technique, preferably DRIE. This means that the carrier is provided with carrier openings which run all the way through the carrier. At this position the carrier is etched away completely. The etching stops for instance at the membrane layer or at an optional layer between the membrane and the carrier, which is thus situated on the other side. The membrane hereby remains wholly or almost wholly intact.

The term “pattern” is a term usual in lithography, which relates to the transferring of a negative to a light-sensitive layer. A water-soluble lacquer is preferably used as light-sensitive layer. This lacquer is then exposed through the negative and cured. The thus obtained pattern is then ready for further processing such as etching.

Surprisingly, it has now been found that by first etching a pattern in an outer layer on the carrier side or the layer applied thereto, and etching this pattern through in a subsequent step, carrier openings are obtained which have a desired size, depth and tapering, without the above stated drawbacks. Carrier openings are obtained which have a great homogeneity in respect of relevant features such as size, depth and tapering. There moreover occurs no or hardly any underetching of the layer for etching. This greatly enhances the strength of the membrane on a carrier.

In yet another embodiment, the invention relates to a method for manufacturing a membrane on a carrier, comprising the steps of

a. providing a carrier;

b. arranging a membrane on a membrane side of the carrier;

c. arranging a layer on a carrier side;

d. arranging and exposing a mask on the membrane side;

e. etching the membrane on the membrane side;

f. arranging and exposing a mask on the carrier side;

g. etching a pattern in the layer on the carrier side;

h. etching through this pattern up to the membrane on the membrane side. In a preferred embodiment according to the invention, the invention relates to a method for manufacturing a membrane on a carrier, wherein after step a) and before step b) an intermediate layer is applied to the membrane side of the carrier, on which intermediate layer the etching through of step h) stops.

In a preferred embodiment according to the invention, the invention relates to a method for manufacturing a membrane on a carrier, wherein a protective layer is deposited on both sides.

An additional effect of the deposition of such a protective layer is that the size of the carrier openings of the carrier and/or membrane can change to some extent. The openings will generally be filled to some extent, whereby they become smaller. The term “intermediate layer” designates a layer which is applied to another layer, in this case to the carrier on the membrane side hereof. The purpose of an intermediate layer is for instance to improve the adhesion between adjacent layers or to obtain a cleaner surface. This layer can further also serve as etching stop in a subsequent process step, such as for instance etching through the carrier from the other side and up to such an intermediate layer. This has the advantage that the etching stops at this layer and does not go further, for instance through the membrane. This membrane is then protected against etching from the other side and is hereby wholly unaffected. A much more homogeneous etching can hereby further be achieved. Use is in fact made here of the difference in etching speed, which is high in the layer for etching and low in the etching stop. An example of a suitable material as intermediate layer is SiO₂.

The term “membrane” designates the layer as defined above. As stated, Si₃N₄ is preferably used for this purpose.

The term “mask” designates a term usual in lithography which comprises the image or the negative of a pattern to be transferred. The image is usually transferred to a photo-sensitive layer or lacquer. This layer or lacquer is generally cured. Another processing step then follows. After this subsequent processing step, the photo-sensitive layer or lacquer is usually removed.

The term “wet etching” is understood to mean a chemical process with which layers or a part of a layer is removed by means of a chemically active solution. This solution is for instance water-based and can for instance contain a hydroxide in the case a metal oxide or semiconductor oxide is being etched. Examples of hydroxides are NaOH and KOH, wherein KOH is recommended. On the membrane side the mask preferably contains a pattern with rectangular slots with a dimension of 0.01×0.1 micrometres to 5.0×5.0 micrometres. The advantage of such slots is that they can be transferred easily with existing lithographic techniques and have a good action.

It will be apparent to the skilled person that, depending on the size of the image, a wavelength will be chosen in a suitable range to enable transferring of the desired pattern. These slots are sufficiently selective, among other reasons because they can be formed sufficiently homogeneously. The precise dimensions of the slots are determined by the application. Examples hereof are the filtering of micro-organisms from milk: a membrane with an average membrane opening of 0.5−1.0×1.0−5.0 micrometres, for filtering of fat an average membrane opening of 0.5−3.0×1.0−10 micrometres, and for filtering of proteins a membrane opening of 0.05−0.2×0.1−1 micrometre. It will be further apparent to the skilled person that a choice for smaller membrane openings is normally associated with a lower rate of flow.

A further advantage of slots compared to round membrane openings is that slots become blocked less easily. Round or substantially round particles present in a liquid for filtering can easily block round membrane openings, while in the case of slots a part of the membrane openings still remains clear. A significant part of the particles in a liquid for filtering is somewhat round. In addition, slots are much easier to clean by means of back-flushing and/or back-pulsing. The term “slot” designates a rectangular membrane opening.

The mask further preferably comprises on the carrier side a pattern with substantially round carrier openings having a diameter of 100 micrometres to 1000 micrometres, more preferably a diameter of 200 micrometres to 500 micrometres, most preferably a diameter of 200 micrometres to 300 micrometres, wherein the carrier openings lie in tracks of 3-15 mm wide with an unexposed space between the tracks of 1-8 nm. In a preferred embodiment these are tracks with a width of about 8 mm and an intermediate space of about 3 mm. Etching of the pattern in the layer on the carrier side preferably takes place by means of RIE. The term “RE” is understood to mean the term Reactive Ion Etching used in chemistry. A chemical process is generally understood here wherein reactive ions remove layers or a part of a layer. Advantages of suitable compositions for etching are known to the skilled person. An example hereof is SF₆/CBF₃/O₂.

FIG. 2 shows a cross-section of a preferred embodiment with an enlarged membrane surface. After the membrane according to FIG. 1 has been manufactured, an isotropic etching treatment with an SF₆ plasma can herein be applied at a lowered temperature (−50 to −150 degrees C.), wherein silicon 21 is removed from the carrier through the openings in the membrane layer to a depth under the membrane layer of for instance 10-100 micrometres. Although the anisotropic openings in the silicon carrier hereby also increase in diameter, this can be taken into account in the membrane design. This method can preferably also be performed with an (optionally pulsated) xenon difluoride gas at lowered temperature (−50 to −150 degrees C.) in order to ensure a good etching selectivity between silicon nitride and silicon. Another method is to apply a wet etching with an HF/HNO₃ solution instead of gaseous etching mixtures. The advantage of these preferred embodiments is that the dimensions of each separate membrane field do not now have to be related directly to the size of the openings in the silicon carrier. Furthermore, the application of an isotropic etching step surprisingly results in mechanically stronger membranes, possibly as a result of more rounded and smooth structures.

The skilled person will likewise be able to readily determine a suitable temperature range as well as a suitable pressure range and etching gas composition, depending on the desired application and the desired result.

Etching through of the pattern onto the carrier side through the core of the carrier preferably takes place by means of DRIE. The term “DRIE” is a term usual in chemistry, Deep Reactive Ion Etching. The difference with RIE lies mainly in the fact that with DRIE, as the name already suggests, relatively deep structures such as carrier openings can be etched in homogeneous manner. This effect is achieved by alternately etching and covering the formed side wall of the carrier openings with a polymer or similar material. This prevents the side being over-etched. Practically perpendicular carrier openings with a small tapering, or a high aspect ratio, are moreover obtained. An example of such a process is the so-called Bosch process. Examples of suitable etching gas compositions for the etching are further known to the skilled person. The skilled person will likewise be readily able to determine a suitable temperature range as well as a suitable pressure range, depending on the desired application and the desired result.

The thickness of the membrane is preferably between 50 nm and 2 micrometres, very preferably between 100 nm and 1.5 micrometres and most preferably 1 micrometre, and the thickness of the layer on the carrier side is preferably between 50 nm and 2 micrometres, very preferably between 100 nm and 1.5 micrometres and most preferably 1 micrometre. It will be apparent from the foregoing that the choice is determined by the desired features and properties of the membrane on a carrier. If the layer becomes too thick, the deposition takes proportionately longer, which is economically unattractive. If the layer is too thin, the layer provides insufficient activity, for instance because it then has an insufficiently homogeneous thickness over the relevant distance range, and the layer is not strong enough. The membrane can be of the above stated materials and is preferably of Si₃N₄. The layer on the carrier side can be of the above stated materials and is preferably of Si₃N₄. Silicon carbide can also be mentioned as a suitable alternative.

The membrane, carrier layer and optional protective layer are preferably deposited by means of a CVD technique, epitaxial growing technique, spin coating or sputtering, very preferably by means of CVD and most preferably by means of LPCVD. The advantage of these techniques is that uniform layers can be deposited in relatively simple and not too expensive manner.

The terms “CVD” and “LPCVD” designate Chemical Vapour Deposition and Low Pressure Chemical Vapour Deposition.

The thickness of the optional protective layer is preferably 30 nm to 1 micrometre, very preferably 40 nm to 200 nm, and is most preferably about 50 nm. Too thin a layer provides insufficient protection, while forming of a thick layer takes too much time. The protective layer can be of the above stated materials and is preferably Si₃N₄.

In a subsequent embodiment, the invention relates to a method for manufacturing a membrane on a carrier, comprising the steps of:
a. depositing at least one electrical conductor in a first direction;
b. covering the at least one electrical conductor in the first direction with a dielectric;
c. depositing at least one electrical conductor in a second direction; and
d. covering the at least one electrical conductor in the second direction with a dielectric.

With such a method according to the invention a network is obtained which covers the membrane and/or the carrier. This network ensures that it is possible to determine in both directions whether there is a fracture. This fracture can be both microscopic and macroscopic. The condition of the membrane and/or the carrier can hereby be determined in simple manner by an external measurement or series of measurements.

The electrical conductors are preferably connected to pads. These pads are in turn preferably provided with an inert and conductive layer such as gold. The pads are used as contact points with the outside world, for instance a device which measures the conduction over the electrical conductors.

The electrical conductors are preferably placed parallel to the main directions of the membrane on a carrier, i.e. parallel and perpendicular to the direction of the sieve tracks.

Examples of materials which can be arranged by usual methods and are suitable as electrical conductors are tungsten, aluminium and silicon, which can optionally be doped in order to increase the conductivity.

The width of the conductors is preferably significantly smaller than the size of the membrane openings and/or the size of the space between the membrane openings and is preferably between 0 nm and 500 nm, more preferably between 200 nm and 300 nm. The thickness of the conductors is preferably between 50 nm and 500 nm, more preferably between 200 and 300 nm. Electrical conductors which are too thin and/or too narrow conduct the current insufficiently and are therefore less suitable. In a subsequent embodiment, the invention relates to the application of a membrane on a carrier according to the invention, or obtained according to a method according to the invention, for filtration of a fluid. It relates particularly to the filtration of a liquid, in particular milk, fruit juice or whey.

Membranes on a carrier according to the invention are particularly suitable for the filtration of liquids, on the one hand because they have an excellent and selectively separating capacity for particles of different sizes and on the other hand because they are easy to apply. A membrane on a carrier according to the invention is furthermore much better resistant to the occurrence of fractures. In addition, much less fouling occurs compared to usual filters. Owing to the particular design of for instance the carrier openings in the membrane on a carrier, the membrane on a carrier according to the invention can also be back-flushed and/or back-pulsed more easily than other filters, whereby cleaning is simplified and improved. This back-flushing and/or back-pulsing further enhances the overall filtration since the filtration proceeds better after the flushing, and back-flushing and/or back-pulsing is necessary less often or for less time, thereby increasing the degree of capacity utilization of a filtration device.

The membrane on a carrier according to the invention is moreover much stronger than heretofore usual and comparable membranes, in the sense that it is possible to withstand much greater pressures.

In a subsequent embodiment, the invention relates to a module provided with a membrane on a carrier according to the invention or obtained in accordance with a method according to the invention. Such a module can for instance consist of a holder in which the membrane on a carrier is enclosed, and which as such can be easily arranged in and removed from a filtration device. The advantage of such a module is that a relatively vulnerable membrane on a carrier is protected during operations such as replacement of the membrane. A module can further be formed such that it can be more readily placed in an existing filtration device compared to a membrane on a carrier as such.

The term “module” designates an assembly of a membrane on a carrier and for instance a holder. This module can for instance be applied in filtration processes.

In a subsequent embodiment, the invention relates to a method for determining fracture in a membrane on a carrier according to the invention or obtained according to the invention, comprising the steps of determining the degree of conductivity of the electrical conductors; localizing a possible fracture on the basis of the information obtained in step a).

In such a manner information relating to the state of the membrane on a carrier according to the invention is readily obtained as already described above. On the basis of the thus obtained information optional further steps can then be undertaken, such as repair or replacement of the membrane on a carrier.

The invention is elucidated on the basis of the non-limitative example, which is only intended by way of illustration of the scope of the invention.

### EXAMPLES

As starting material is taken a silicon wafer with a dimension of 6 inches in diameter and a thickness of 525 micrometres. Using known techniques a layer of silicon oxide is applied which later serves as stop layer for the Deep Reactive Ion Etching process. The thickness of this layer is about 100 nm. Later in the process this layer will lie between the silicon and the silicon nitride on the side where the membrane will be situated.

Using Low Pressure Chemical Vapour Deposition (PCVD) a layer of silicon-rich silicon nitride with a thickness of 1 micrometre is applied to both sides.

On top of this layer of silicon nitride a photo-lacquer layer is applied by means of spin coating. A pattern representing the membrane openings is arranged in this layer with photolithography. These are slots with a size of 2.0×0.8 micrometres.

A mask is now arranged on the carrier side with photographic techniques. A framework is used which consists of 11 tracks, each 8 mm wide with 3 mm intermediate spacing. The carrier openings are then arranged in this framework as follows. On the carrier side a mask is used which consists solely of round carrier openings with a diameter of 250 micrometres.

Both the perforations are aligned relative to each other so that the entire micro-perforated part eventually becomes freely suspended.

Using Reactive Ion Etching (RIE), this photo-sensitive pattern is transferred into the silicon nitride. This takes place successively on both sides.

Using Deep Reactive Ion Etching (DRIE), straight carrier openings are formed right through the silicon wafer as far as the silicon oxide stop layer on the other side. This method according to the present invention provides the following advantages:

a) it facilitates back-flushing and back-pulsing of the membrane during use; b) the difference between D.R.I.E. and R.I.E. is that with D.R.I.E. a substantially conical carrier opening is obtained up to the silicon oxide stop layer without underetching taking place. This is because the lateral etching speed is much lower in D.R.I.E. than in R.I.E. (the etching speed parallel to the wafer is much lower than the etching speed perpendicularly).

In order to further increase the strength of the 6 inch wafers for the purpose of use, the wafer is provided with sieve tracks, in this case 11 units, each 8 mm wide and varying in length from 6 to 12 cm, wherein the length is determined substantially by the position on the wafer. Between each sieve track is a space of 3 mm. This space is used to clamp the filter in a module. The strength of the filter increases enormously due to the combination of sieve tracks and the round carrier openings.

As a final step an LPCVD deposition with Si₃N₄ once more takes place so as to again provide all surface with homogeneous (3D covering process) 50 nm Si₃N₄ so that the inertia remains guaranteed during use. Si₃N₄ can after all well withstand alkaline and/or acid cleaning.

The invention is not limited to the above outlined carrier openings, which can have a mutually differing diameter, mutually differing shape, for instance have rectangular, polygonal, round and/or oval carrier openings adjacently of each other and/or mixed together in order to reduce the build-up of mechanical stress in the carrier. If desired, the carrier can also be provided with a very strong and tough (for instance SP₃ carbon) envelope to prevent crack initiation in the case of possible overloading.

Nor is the invention limited to a carrier with one membrane layer, a carrier can be provided without problem with more than one membrane layer through the use of at least one sacrificial layer. A particular embodiment has the feature that both the bottom and the top side of the carrier are provided with a membrane layer, and wherein the openings are arranged in the carrier with a dry etching process (plasma etching) performed via the already present holes in one or two membrane layers. Depending on the application, for instance dead-end filtration, membrane emulsification or membrane atomization, this configuration provides the advantage that undesired accumulation of particles in the openings of the carrier can hereby be prevented. The one membrane layer can hereby act as a pre-filter for the other membrane layer which has a different functionality. Such a configuration can also be cleaned relatively easily by applying a cross flow on both membrane sides. Relatively thin carrier material with a thickness between 10 and 100 micrometres can advantageously be applied for relatively small chips with a dimension smaller than for instance 5 by 5 mm, since the necessary plasma etching times are then relatively short. A membrane layer can also be provided with an electrically conductive layer intended for electrowetting of the surface, with the advantage of an improved anti-fouling behaviour.

1. Device comprising a membrane on a carrier, wherein the membrane is provided with at least one membrane opening and the carrier with at least one carrier opening, characterized in that the carrier opening has a rounded cross-section.

2. Device as claimed in claim 1, characterized in that the carrier opening has a surface roughness of smaller than 3 micrometres, and in particular smaller than 0.3 micrometre.

3. Device as claimed in claim 1, characterized in that a pattern of carrier openings is arranged in the carrier such that a first part-pattern has a first density of carrier openings, a second part-pattern adjacent to the first part-pattern has a second density of carrier openings, and a third part-pattern adjacent to the second part-pattern has a third density of carrier openings, wherein the second density is smaller than the first density and greater than the third density, and the second density is preferably less than half the first density.

4. Membrane on a carrier as claimed in claim 1, characterized in that the carrier is provided with continuous elongate patterns, wherein the patterns have an almost equal density of carrier openings.

5. Device as claimed in, characterized in that the carrier comprises single-crystalline material with preferred crystal orientation and that the carrier comprises openings having walls with directions substantially differing from the preferred crystal orientation.

6. Device as claimed in claim 1, characterized in that the carrier is manufactured from polycrystalline silicon.

7. Device as claimed in claim 1, characterized in that one or more of the walls of the carrier openings are substantially perpendicular to the surface of the carrier, or have a positive tapering or a negative tapering relative to said surface.

8. Device as claimed in claim 1, characterized in that the membrane comprises a number of membrane fields which are arranged mutually offset and wherein a surface area of a membrane field is two to twenty times greater than a surface area of one or more carrier openings corresponding therewith.

9. Device as claimed in claim 1, characterized in that the carrier opening is provided just below the membrane with a cup having a cross-section which is about one to fifty times, and preferably two to ten times, a cross-section of a carrier opening located further away.

10. Device as claimed in claim 9, characterized in that a flow resistance of the carrier opening is about five to a hundred and preferably ten to fifty times lower than a flow resistance of the corresponding membrane field.

11. Device as claimed in claim 1, characterized in that the membrane and the carrier are each provided with a chemically inert protective layer, preferably with a thickness between 1 and 350 nanometres.

12. Device as claimed in claim 11, characterized in that the chemically inert protective layer is hydrophilic.

13. Device as claimed in claim 1, characterized in that the carrier is provided on two sides with a membrane, each with at least one membrane opening.

14. Device as claimed in claim 1, characterized in that the membrane is provided with at least one electrical conductor enclosed by a dielectric.

15. Device as claimed in claim 14, characterized in that the membrane is provided with at least one electrical conductor in a first direction and at least one electrical conductor in a second, different direction.

16. Device comprising a membrane on a carrier, characterized in that the carrier is provided with continuous sieve tracks.

17. Method for manufacturing a membrane on a carrier, comprising the steps of
a. providing a membrane on a first side of the carrier, which carrier is provided on a second side with a layer for etching;
b. etching a pattern in the layer for etching on the second side of the carrier, and
c. etching the pattern obtained in step b) through the core of the carrier up to the membrane.

18. Method for manufacturing a membrane on a carrier, comprising the steps of
a. providing a carrier;
b. arranging a membrane on a membrane side of the carrier;
c. arranging a layer on a carrier side;
d. arranging and exposing a mask on the membrane side;
e. etching the membrane on the membrane side;
f. arranging and exposing a mask on the carrier side;
g. etching a pattern in the layer on the carrier side;
h. etching through this pattern up to the membrane on the membrane side.

19. Method for manufacturing a membrane on a carrier as claimed in claim 17, wherein before step b) an intermediate layer is applied to the membrane side of the carrier, on which intermediate layer the etching through of step h) stops.

20. Method for manufacturing a membrane on a carrier as claimed in claim 17, wherein a protective layer is deposited on both sides of the membrane and on the carrier.

21. Method for manufacturing a membrane on a carrier suitable for an integrity test, comprising the steps of:
a. depositing at least one electrical conductor in a first direction;
b. covering the at least one electrical conductor in the first direction with a dielectric;
c. depositing at least one electrical conductor in a second direction; and
d. covering the at least one electrical conductor in the second direction with a dielectric.

22. Application of a membrane on a carrier as claimed in claim 1, for filtration of a fluid.

23. Application as claimed in claim 22, wherein the fluid comprises a dairy beverage, in particular milk, wherein for filtering of micro-organisms an average membrane opening of 0.5−1.0×1.0−5.0 micrometres is applied, for filtering of fat an average membrane opening of 0.5−3.0×1.0−10 micrometres, and for filtering of proteins a membrane opening of 0.05−0.2×0.1−1 micrometre is applied.

24. Module provided with a membrane on a carrier as claimed in claim 1.

25. Membrane on a carrier manufactured according to the method as claimed in claim 17.

26. Method for determining fracture in a membrane on a carrier as claimed in claim 1, comprising the steps of
a. determining the degree of conductivity of the electrical conductors;
b. localizing a possible fracture on the basis of the information obtained in step a).
